(19) United States
(12) Patent Application Publication
(10) Pub. No.: US 2005/0170962 A1
(43) Pub. Date: Aug. 4, 2005

(54) Herbicidal composition

(76) Inventor: Matthias Brandl, Madrid (ES)

Correspondence Address: SYNGENTA CROP PROTECTION , INC.;PATENT AND TRADEMARK DEPARTMENT, 410 SWING ROAD, GREENSBORO, NC, 27409, US

(21) Appl. No.: 10/508,732

(22) PCT Filed: Mar. 20, 2003
(86) PCT No.: PCT/EP03/02924

(30) Foreign Application Priority Data
Mar. 21, 2002 (CH) 495/02

(51) Int. Cl. A01N 25/32; A01N 43/60

(52) U.S. Cl. 504/104; 504/136

(57) ABSTRACT

A selectively herbicidal composition for controlling grasses and weeds in crops of useful plants, comprising
a) a herbicidally effective amount of a compound of formula I 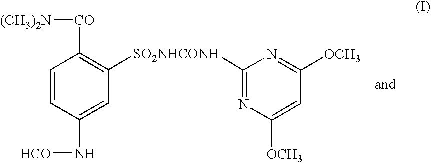
b) an amount, effective for herbicide antagonism, of a compound of formula II 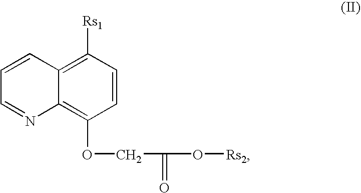
wherein the substituents are as defined in claim 1.

The present invention relates to new selectively herbicidal compositions for controlling grasses and weeds in crops of useful plants, especially in crops of cereals such as wheat, barley, rye, sorghum and millet, which compositions comprise a herbicide and a safener (counter-agent, antidote) and protect the useful plants but not the weeds against the phytotoxic action of the herbicide, and to the use of such a composition in controlling weeds in crops of useful plants.

The use of herbicides can result in considerable damage also being caused to cultivated plants, for example in dependence upon the concentration of the herbicide and the mode of its application, the cultivated plant, the nature of the soil and the climatic conditions, such as period of exposure to light, temperature and amounts of precipitation. In order to counter those and similar problems, various substances have already been proposed as safeners that are capable of antagonising the damaging action of the herbicide on the cultivated plant, that is to say of protecting the cultivated plant against that action, while the herbicidal action on the weeds to be controlled is virtually unimpaired. It has been found that the proposed safeners often have a very specific action both in respect of the cultivated plants and in respect of the herbicide and in some cases also in dependence upon the mode of application. This means that a specific safener is often suitable only for a specific cultivated plant and a particular class of herbicide or a specific herbicide. For example, quinoline compounds are known from EP-A-94 349 which protect the cultivated plants against the phytotoxic action of herbicides such as, for example, pyridyloxyphenoxypropionic acid esters.

It has now been found that compounds of formula II 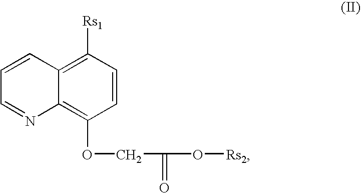
wherein Rs₁ is hydrogen or chlorine and Rs₂ is hydrogen, C₁-C₈alkyl, or C₁-C₈alkyl substituted by C₁-C₆alkoxy or by C₃-C₆alkenyloxy, are suitable for protecting cultivated plants against the phytotoxic action of a particular sulfonylurea herbicide known from EP-A-757 679.

There is accordingly proposed, in accordance with the invention, a selectively herbicidal composition that, in addition to comprising customary inert formulation adjuvants such as carriers, solvents and wetting agents, comprises as active ingredient a mixture of
a) a herbicidally effective amount of a herbicide of formula I 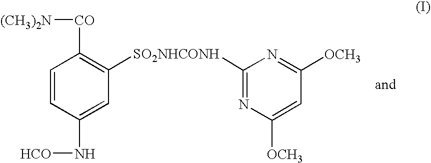
b) an amount, effective for herbicide antagonism, of a safener of formula II 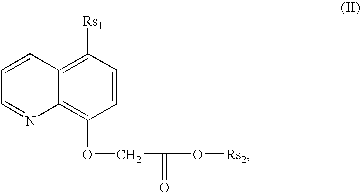
   wherein Rs₁ is hydrogen or chlorine and Rs₂ is hydrogen, C₁-C₈alkyl, or C₁-C₈alkyl substituted by C₁-C₆alkoxy or by C₃-C₆alkenyloxy.

The invention relates also to a method for the selective control of weeds in crops of useful plants, which method comprises treating the useful plants, their seeds or cuttings or the area of cultivation thereof, simultaneously or separately, with a herbicidally effective amount of the herbicide of formula I and an amount, effective for herbicide antagonism, of the safener of formula II.

Cultivated plants that may be protected against the harmful effect of the above-mentioned herbicides by means of the safeners of formula II are especially types of cereals such as barley, rye, sorghum, millet and, especially, wheat. Crops are to be understood as including those that have been made tolerant to herbicides or classes of herbicides by means of conventional breeding or genetic engineering methods. The weeds to be controlled may be either monocotyledonous or dicotyledonous weeds such as, for example, Stellaria, Nasturtium, Agrostis, Digitaria, Avena, Setaria, Sinapis, Lolium, Solanum, Echinochloa, Scirpus, Monochoria, Sagittaria, Bromus, Alopecurus, Sorghum halepense, Rottboellia, Cyperus, Abutilon, Sida, Xanthium, Amaranthus, Chenopodium, Ipomoea, Chrysanthemum, Galium, Viola and Veronica. Areas of cultivation are areas of land on which the cultivated plants are already growing or in which the seeds of those cultivated plants have been sown, and also land on which it is intended to grow those cultivated plants.

A safener of formula II may, depending on the intended purpose, be used to pre-treat the seed material of the cultivated plant (dressing the seed or the cuttings) or may be incorporated into the soil before or after sowing. It may, however, also be applied, alone or together with the herbicide, after the emergence of the plants. The treatment of the plants or seed with the safener can therefore, in principle, be effected independently of the time at which the herbicide is applied. The treatment of the plants can, however, also be carried out by applying the herbicide and safener simultaneously (for example in the form of a tank mixture). The rate of application of the safener in relation to the herbicide depends largely on the method of application. In the case of field treatment, which is effected either using a tank mixture with a combination of the safener and the herbicide or by the separate application of the safener and the herbicide, the ratio of herbicide to safener is generally from 100:1 to 1:10, preferably from 5:1 to 1:8. In the case of field treatment, from 0.001 to 5.0 kg of safener/ha, preferably from 0.001 to 0.5 kg of safener/ha, are generally applied. The rate of application of herbicide is generally from 0.001.to 2 kg/ha, but-preferably-from 0.005 to 1 kg/ha.

The compositions according to the invention are suitable for all methods of application that are customary in agriculture, for example pre-emergence application, post-emergence application and seed dressing. In the case of seed dressing, from 0.001 to 10 g of safener/kg of seed, preferably from 0.05 to 2 g of safener/kg of seed, are generally applied. When the safener is applied in liquid form shortly before sowing, with swelling of the seed, it is advantageous to use safener solutions that comprise the active ingredient in a concentration of from 1 to 10 000 ppm, preferably from 100 to 1000 ppm.

For application, the safeners of formula II or combinations of those safeners with the herbicides of formula I are advantageously processed, together with the adjuvants conventionally employed in formulation technology, into formulations, for example into emulsifiable concentrates, coatable pastes, directly sprayable or dilutable solutions, dilute emulsions, wettable powders, soluble powders, dusts, granules or microcapsules. Such formulations are described, for example, in WO 97/34485, on pages 9 to 13. The formulations are prepared in known manner, for example by intimately mixing and/or grinding the active ingredients with liquid or solid formulation adjuvants, for example solvents or solid carriers. Furthermore, surface-active compounds (surfactants) may additionally be used in the preparation of the formulations. Solvents and solid carriers that are suitable for that purpose are mentioned, for example, in WO 97/34485 on page 6.

Suitable surface-active compounds are, depending on the nature of the compound of formula I being formulated, non-ionic, cationic and/or anionic surfactants and mixtures of surfactants having good emulsifying, dispersing and wetting properties. Examples of suitable anionic, non-ionic and cationic surfactants are listed, for example, in WO 97/34485 on pages 7 and 8. Furthermore, the surfactants customarily employed in formulation technology, which are described, inter alia, in “Mc Cutcheon's Detergents and Emulsifiers Annual” MC Publishing Corp., Ridgewood N.J., 1981, Stache, H., “Tensid-Taschenbuch”, Carl Hanser Verlag, Munich/Vienna, 1981 and M. and J. Ash, “Encyclopedia of Surfactants”, Vol I-III, Chemical Publishing Co., New York, 1980-81, are also suitable for preparation of the herbicidal compositions according to the invention.

The herbicidal formulations generally comprise from 0.1 to 99% by weight, especially from 0.1 to 95% by weight, of active ingredient mixture comprising the compound of formula I together with the compounds of formula II, from 1 to 99.9% by weight of a solid or liquid formulation adjuvant and from 0 to 25% by weight, especially from 0.1 to 25% by weight, of a surfactant. Whereas commercial products usually will preferably be in the form of concentrates, the end user will normally employ dilute formulations.

The compositions may also comprise further additives such as stabilisers, for example vegetable oils or epoxidised vegetable oils (epoxidised coconut oil, rapeseed oil or soybean oil), antifoams, for example silicone oil, preservatives, viscosity regulators, binders and tackifiers, as well as fertilisers or other active ingredients. There are various suitable methods and techniques for using safeners of formula II or compositions comprising them for protecting cultivated plants against harmful effects of herbicides of formula I; the following are examples:
i) Seed dressing
   a) Dressing the seeds with a wettable powder formulation of a compound of formula II by shaking in a vessel until the formulation is uniformly distributed over the seed surface (dry dressing). Approximately from 1 to 500 g of compound of formula II (from 4 g to 2 kg of wettable powder) are used per 100 kg of seed material.
   b) Dressing the seeds with an emulsifiable concentrate of the compound of formula II according to method a) (wet dressing).
   c) Dressing by immersing the seed material in a liquid formulation comprising from 100 to 1000 ppm of compound of formula II for from 1 to 72 hours and, if desired, subsequently drying the seeds (immersion dressing).

Dressing the seed material or treating the germinated seedlings are naturally the preferred methods of application because the treatment with the active ingredient is directed wholly at the target crop. Generally from 1 to 1000 g of antidote, preferably from 5 to 250 g of antidote, are used per 100 kg of seed material, although, depending on the method employed, which also allows the addition of other active ingredients or micronutrients, amounts above or below the specified concentration limits may be employed (repeat dressing).
ii) Application in the form of a tank mixture
   A liquid formulation of a mixture of antidote and herbicide (ratio of the one to the other from 10:1 to 1:100) is used, the rate of application of herbicide being from 0.005 to 5.0 kg per hectare. Such tank mixtures are applied before or after sowing.
iii) Application to the seed furrow
   The compound of formula II is introduced into the open, sown seed furrow in the form of an emulsifiable concentrate, a wettable powder or granules. After the seed furrow has been covered, the herbicide is applied pre-emergence in the normal manner.
iv) Controlled release of the active ingredient
   The compound of formula II is applied in solution to granulated mineral carriers or polymerised granules (urea-formaldehyde) and dried. If desired, a coating may be applied (coated granules) that enables the active ingredient to be released in metered amounts over a predetermined period of time.

Preferred formulations have especially the following compositions (%=percent by weight; ‘active ingredient mixture’ denotes the mixture of compound of formula I with the compound of formula II)
Emulsifiable concentrates:
   active ingredient mixture: from 1 to 90%, preferably from 5 to 20%
   surface-active agent: from 1 to 30%, preferably from 10 to 20%
   liquid carrier: from 5 to 94%, preferably from 70 to 85%
Dusts:
   active ingredient mixture: from 0.1 to 10%, preferably from 0.1 to 5%
   solid carrier: from 99.9 to 90%, preferably from 99.9 to 99%
Suspension concentrates:
   active ingredient mixture: from 5 to 75%, preferably from 10 to 50%
   water: from 94 to 24%, preferably from 88 to 30%
   surface-active agent: from 1 to 40%, preferably from 2 to 30%
Wettable powders:
   active ingredient mixture: from 0.5 to 90%, preferably from 1 to 80%
   surface-active agent: from 0.5 to 20%, preferably from 1 to 15%
   solid carrier: from 5 to 95%, preferably from 15 to 90%
Granules:
   active ingredient mixture: from 0.1 to 30%, preferably from 0.1 to 15%
   solid carrier: from 99.5 to 70%, preferably from 97 to 85%

The Examples that follow illustrate the invention further. They do not limit the invention. Formulation Examples for mixtures comprising the herbicide of formula I and the safener of formula II (%=% by weight)

| F1. Emulsifiable concentrates | a) | b) | c) | d) |
|---|---|---|---|---|
| active ingredient mixture | 5% | 10% | 25% | 50% |
| calcium dodecylbenzenesulfonate | 6% | 8% | 6% | 8% |
| castor oil polyglycol ether | 4% | — | 4% | 4% |
| (36 mol of ethylene oxide) | | | | |
| octylphenol polyglycol ether | — | 4% | — | 2% |
| (7-8 mol of ethylene oxide) | | | | |
| cyclohexanone | — | — | 10% | 20% |
| aromatic C₉-C₁₂ hydrocarbon mixture | 85% | 78% | 55% | 16% |

Emulsions of any desired concentration can be prepared from such concentrates by dilution with water.

| F2. Solutions | a) | b) | c) | d) |
|---|---|---|---|---|
| active ingredient mixture | 5% | 10% | 50% | 90% |
| 1-methoxy-3-(3-methoxy- | — | 20% | 20% | — |
| propoxy)-propane | | | | |
| polyethylene glycol (mol. wt. 400) | 20% | 10% | — | — |
| N-methyl-2-pyrrolidone | — | — | 30% | 10% |
| aromatic C₉-C₁₂ hydrocarbon mixture | 75% | 60% | — | — |

The solutions are suitable for application in the form of micro-drops.

| F3. Wettable powders | a) | b) | c) | d) |
|---|---|---|---|---|
| active ingredient mixture | 5% | 25% | 50% | 80% |
| sodium lignosulfonate | 4% | — | 3% | — |
| sodium lauryl sulfate | 2% | 3% | — | 4% |
| sodium diisobutylnaphthalenesulfonate | — | 6% | 5% | 6% |
| octylphenol polyglycol ether | — | 1% | 2% | — |
| (7-8 mol of ethylene oxide) | | | | |
| highly dispersed silicic acid | 1% | 3% | 5% | 10% |
| kaolin | 88% | 62% | 35% | — |

The active ingredient is mixed thoroughly with the adjuvants and the mixture is thoroughly ground in a suitable mill, affording wettable powders which can be diluted with water to give suspensions of any desired concentration.

| F4. Coated granules | a) | b) | c) |
|---|---|---|---|
| active ingredient mixture | 0.1% | 5% | 15% |
| highly dispersed silicic acid | 0.9% | 2% | 2% |
| inorganic carrier material | 99.0% | 93% | 83% |
| (diameter 0.1-1 mm) | | | |
| for example CaCO₃ or SiO₂ | | | |

The active ingredient is dissolved in methylene chloride, the solution is sprayed onto the carrier, and the solvent is subsequently evaporated off in vacuo.

| F5. Coated granules | a) | b) | c) |
|---|---|---|---|
| active ingredient mixture | 0.1% | 5% | 15% |
| polyethylene glycol (mol. wt. 200) | 1.0% | 2% | 3% |
| highly dispersed silicic acid | 0.9% | 1% | 2% |
| inorganic carrier material | 98.0% | 92% | 80% |
| (diameter 0.1-1 mm) | | | |
| for example CaCO₃ or SiO₂ | | | |

The finely ground active ingredient is uniformly applied, in a mixer, to the carrier material moistened with polyethylene glycol, yielding non-dusty coated granules.

| F6. Extruder granules | a) | b) | c) | d) |
|---|---|---|---|---|
| active ingredient mixture | 0.1% | 3% | 5% | 15% |
| sodium lignosulfonate | 1.5% | 2% | 3% | 4% |
| carboxymethylcellulose | 1.4% | 2% | 2% | 2% |
| kaolin | 97.0% | 93% | 90% | 79% |

The active ingredient is mixed with the adjuvants, and the mixture is ground, moistened with water, extruded and then dried in a stream of air.

| F7. Dusts | a) | b) | c) |
|---|---|---|---|
| active ingredient mixture | 0.1% | 1% | 5% |
| talcum | 39.9% | 49% | 35% |
| kaolin | 60.0% | 50% | 60% |

Ready-to-use dusts are obtained by mixing the active ingredient with the carriers and grinding the mixture in a suitable mill.

| F8. Suspension concentrates | a) | b) | c) | d) |
|---|---|---|---|---|
| active ingredient mixture | 3% | 10% | 25% | 50% |
| ethylene glycol | 5% | 5% | 5% | 5% |
| nonylphenol polyglycol ether | — | 1% | 2% | — |
| (15 mol of ethylene oxide) | | | | |
| sodium lignosulfonate | 3% | 3% | 4% | 5% |
| carboxymethylcellulose | 1% | 1% | 1% | 1% |
| 37% aqueous formaldehyde | 0.2% | 0.2% | 0.2% | 0.2% |
| solution | | | | |
| silicone oil emulsion | 0.8% | 0.8% | 0.8% | 0.8% |
| water | 87% | 79% | 62% | 38% |

The finely ground active ingredient is intimately mixed with the adjuvants, giving a suspension concentrate from which suspensions of any desired concentration can be obtained by dilution with water.

It is often more practical to formulate the compound of formula I and the mixing partner of formula II separately and then, shortly before application, to bring them together in the applicator in the desired mixing ratio in the form of a “tank mixture” in water.

The ability of the safeners of formula II to protect cultivated plants against the phytotoxic action of herbicides of formula I is illustrated in the following Examples.

### BIOLOGICAL EXAMPLES

### Example B1

Post-Emergence Test:

The test plants are grown in pots under greenhouse conditions until a post-application stage. A standard soil is used as cultivation substrate. At a post-emergence stage, the herbicides, both on their own and in admixture with safeners, are applied to the test plants or to cultivated plants seed-dressed with safeners. The rates of application depend on the optimum doses ascertained under field conditions or greenhouse conditions. The tests are evaluated after from 2 to 4 weeks (100% action=plant is completely dead; 0% action=no phytotoxic action). The mixtures used in this test show good results.

### Example B2

Pre-Emergence Test:

The test plants are sown in pots under greenhouse conditions. A standard soil is used as cultivation substrate. At a pre-emergence stage, the herbicides, both on their own and in admixture with safeners, are applied to the surface of the soil or to cultivated plants seed-dressed with safeners. The rates of application depend on the optimum doses ascertained under field conditions or greenhouse conditions. The tests are evaluated after from 2 to 4 weeks (100% action=plant is completely dead; 0% action=no phytotoxic action). The mixtures used in this test show good results.

The same results are obtained when the active ingredient mixture is formulated in accordance with the other above-mentioned Formulation Examples.

1. A selectively herbicidal composition which, in addition to comprising customary inert formulation adjuvants, comprises as active ingredient a mixture of
a) a herbicidally effective amount of a compound of formula I 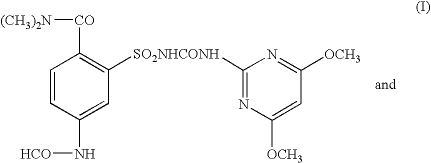
b) an amount, effective for herbicide antagonism, of a safener of formula II 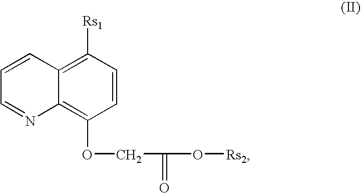
wherein Rs₁ is hydrogen or chlorine and Rs₂ is hydrogen, C₁-C₈alkyl, or C₁-C₈alkyl substituted by C₁-C₆alkoxy or by C₃-C₆alkenyloxy.

2. A method of selectively controlling weeds and grasses in crops of useful plants, which method comprises treating the useful plants, their seeds or cuttings or the area of cultivation thereof, simultaneously or separately, with a herbicidally effective amount of the herbicide of formula I and an amount, effective for herbicide antagonism, of the safener of formula II.

3. A method according to claim 2, wherein the crop of useful plants is a cereal.
